(19) United States
(12) Patent Application Publication
(10) Pub. No.: US 2020/0216751 A1
(43) Pub. Date: Jul. 9, 2020

(54) MICROPROPPANT

(71) Applicant: Pattison Sand Company, LLC, Clayton, IA (US)

(72) Inventor: Thomas Edmund Wilson, Gainesville, FL (US)

(21) Appl. No.: 16/242,714

(22) Filed: Jan. 8, 2019

(51) Int. Cl. C09K 8/80; C09K 8/70; E21B 43/267

(52) U.S. Cl. CPC C09K 8/805; E21B 43/267; C09K 8/70

(57) ABSTRACT

A novel microproppant for holding open secondary fractures in a well exhibits increased crush resistance, deformability, varied lattice structure, and grain boundaries improved to resist cracking and formation of shards. It is adjustable relative to size and durability and exhibits irregular shape. The microproppant composition comprises a plurality of small particles of one or more of zirconium, zirconium/aluminum, aluminum/zirconium and diluent and comprises particle size distribution of any one or more of D50 5 microns, 20 microns, and 50 microns. The microproppant is made by coating a plurality of sand particles with at least one of a small particle oxide of zirconium and/or zirconium aluminum.

### BACKGROUND

### Field of the Disclosure

The present invention addresses a need in the oil recovery arts. Specifically, the invention comprises a material or materials employed as a proppant to increase oil and gas yield per well and a method of making or preparing the material. Microproppants are used to prop open secondary fractures in the well, thereby facilitating outward migration of oil and gas from the well resulting in increased oil and gas yields. Specifically, microproppants and nanoproppants can enter fractures that are too small for conventional proppants, thereby increasing the overall oil and gas yield. The present invention comprises a new microproppant which may be employed as a stand-alone microproppant or as a coating on other proppant materials.

Early Oil Recovery.

Some subsurface rock units such as organic shale contain large amounts of oil, natural gas or natural gas liquids. According to at least one source, the earliest known oil wells were drilled in China in 347 CE. These wells had depths of up to about 240 meters (790 ft) and were drilled using bits attached to bamboo poles. The oil was burned to evaporate brine and produce salt. By the 10th century, extensive bamboo pipelines connected oil wells with salt springs. The ancient records of China and Japan are said to contain many allusions to the use of natural gas for lighting and heating. Petroleum was known as Burning water in Japan in the 7th century. As would be expected, more uses of the oil and more methods of refining the oil were developed. Likewise, the methods for determining where to drill and the structures employed to drill the oil wells have also been improved and exhibit clear advancements over the centuries.

Current Methods of Oil Recovery.

One example of a basic, more modern oil recovery technique includes hydraulic fracturing or fracking. Fracking is employed to create fractures in the shale formation to release the oil and gas. Generally, the process works by drilling a well into the rock, and a portion of the well in the petroleum-bearing zone is sealed. The Frac process can be carried out vertically or, more commonly, by drilling horizontally through the rock layer, and can create new pathways to release gas or can be used to extend existing channels.

Pumps are usually positioned at the surface and inject water (which may include additional components and, in either case, may be called a “fracturing fluid”) into the sealed portion of the well. The pumps are used to increase the fluid pressure in the sealed portion of the well until it is high enough (e.g., ca. 100 bar) to create fractures or to widen existing fractures in the surrounding rocks or shale formations. The fracturing fluid rushes into the fractures, carrying with it sand grains or other materials, inflating the fractures and extending them deeper into the rock. Generally, fracturing fluid comprises water, sand (known as “frac sand” in the industry), other materials known as “proppants” and, perhaps, chemicals.

Since the first fracturing operation was done with silica sand proppant in 1947, many materials have been used as proppants including walnut hulls, natural sand, glass, resin coated sand, sintered bauxite and kaolin, and fused zirconia. The main function of traditional proppants is to provide and maintain conductive fractures during well production.

The sand and other proppants are carried by the fracturing fluid into the fractures. After the pressured injection of fracturing fluid ends or is reduced, those fractures thereafter retract under the normal pressures surrounding them. As they retract, the sand and/or proppants become lodged therein with varying gaps and spaces between proppant particles thereby maintaining the fracture in a fluidly connected state with the well. If the fracture is adequately propped open, the fracture provides a conduit through which oil and gas can flow out to the head of the well and, thereafter, recovered.

### SUMMARY

### Prior Art Problems

Each well can require several thousand tons of Frac sand carried by fracturing fluid in order to stimulate oil flow and to create adequate fracturing to facilitate fluid outflow. Although improvements to the fracking and oil and gas recovery process have definitely been made, the challenge of efficiently reaching and retrieving oil from subsurface rock units remains and could benefit from improvement. Even at this time the majority of the oil and gas reserve is not removed from the formation.

Several thousand tons of Frac sand can be required to stimulate a single well. In addition, or alternatively, to the use of sand and other proppants, the water used to convey proppants may be treated with chemicals and thickeners such as guar gum to create a viscous gel to facilitate the water's ability to carry grains of Frac sand in suspension and into the fractures in the well. The current trend in the oil industry is to pump more tons of sand per job; and to further lateral travel of the sand with horizontal drilling and using smaller proppants which are carried further into the complex frac regions of the well. Microproppants can provide this property since they are light as well as small enough to enter the natural fractures of the formation. Still, most proppants (including most microproppants) comprise density that causes premature settling of the microproppant before it reaches its intended position in the fractures. In either case, accurate placement of sand facilitates yield of the well.

In addition to placement, character of the frac sand dictates its success relative to its specific purpose. Frac sand and other material used for the same purpose come in many shapes, sizes, and characteristics. Frac sand is typically a high-purity quartz sand with very durable and very round grains. Most frac sand is a natural material made from high-purity sandstone. Alternative products are ceramic beads made from sintered bauxite or small metal beads made from aluminum. In either case, the size of the material and its hardness are critical features that affect yields.

Often, oil will not flow freely or will cease to flow freely from a well because the fractured rock unit either closes because it is not propped open, lacks permeability (interconnected pore spaces), or the pore spaces in or between the rocks are so small that these fluids cannot flow through them because of size and charge relationship. Further, as previously mentioned, when the high-pressure water pumps employed in a fracking operation carrying liquid and sand are turned off, unless material of applicable size and strength is accurately placed along with the sand in the fractures created by the fracking process to prop open the fractures, those fractures will typically deflate within about 90 days to a degree that substantially reduces or eliminates flow of oil and gas out of the well, re-trapping it in its subterranean locale. Deflated portions of the fractures will not close completely if there is enough material remaining in the fractures. Therefore, lack of adequate flow characteristics may be improved by accompanying or following frac sand with adequate, targeted, placement of proppants of right size and hardness for the specific well's conditions and objectives.

Proppant sizes are generally between 8 and 140 mesh (105 μm-2.38 mm). The mesh size is the number of openings across one linear inch of screen. When describing the size of the proppant, the proppant is often referred to as simply the sieve cut. For example, 16/30 mesh is 595 μm-1190 μm; 20/40 mesh is 420 μm-841 μm; 30/50 mesh is 297 μm-595 μm; 40/70 mesh is 210 μm-420 μm; 70/140 mesh is 105 μm-210 μm. Typically, larger particle sizes provide higher fracture conductivity.

The traditional fracture treatment will start with smaller particle size proppant and tailor with larger particle size proppant to maximize the near-wellbore conductivity. Some factors which can cause underperformance in the field include non-Darcy or multiphase flow, fines plugging, proppant embedment, formation spalling, filter cake build up, and gel damage. The net effect can result in around 9% reduction in conductivity compared to the baseline conductivity.

But if proppants could be tailored specifically to their purpose they may be more productive and effective, remaining in the fractures thereby propping open the fractures to allow oil and gas to outflow for recovery. One way to improve the process would be to improve the proppants, customizing them for strength, shape, size, and electrical charge. Controlling for bulk density would also improve the proppant. Reducing flow back providing a degree of deformability would improve the proppant performance relative to its specific purposes. However, these objectives are neither simple nor easily achieved. Further, by tailoring proppants for different purposes, the right sized proppant of appropriate hardness and strength could be placed deliberately. This placement, done correctly, would result in better oil and gas yield. Providing proppants tailored for their intended use and for use with specific fracturing fluids would be advantageous. However, until now, proppants were more often selected from naturally available materials rather than tailor made, and suffered from a variety of inefficiencies including inadequate crush strength. And, crushed proppants, of course, no longer hold open fractures but, instead, become part of a blockage or narrowing, completely negating their original purpose. It is, therefore, important to design and produce proppants tailored for size, strength and other characteristics that foster open fracture networks to allow outflow of fluids.

Said simply, the better suited the proppant, the better the yield for that well will be. Keeping the fractures open allows oil and gas to flow and be recovered. In essence, frac sand particles and other proppant materials of deliberate, controlled and adjustable strength and size that “prop” open the fractures and thereby form a network of pore space that allows petroleum fluids to flow out of the rock and into the well would be advantageous. If, instead, the fractures are allowed to close, the petroleum fluids are prevented from outflowing. Finding right-sized, right-strength proppants is an ongoing continuing challenge. Therefore, proppants must be designed to address the specific needs for a particular fracking project.

As previously described, there are a variety of materials employed as proppants for the purposes of holding the fractures open. Petroleum industry proppants are required to meet demanding specifications. For example, the characteristics of a high-quality frac sand and many other proppants include:
high-purity
grain size perfectly matched to job requirements
shape that enables the proppant to be carried in hydraulic fracturing fluid with minimal turbulence and therefore farther into formation,
and durability to resist crushing forces of closing fractures

Frac sand is produced in a range of sizes from as small as 0.1 millimeter in diameter to over 2 millimeters in diameter. Most of the frac sand consumed is between 0.4 and 0.8 millimeters in size. Sand at this size may not exhibit appropriate strength for the purpose of holding fractures open. Therefore, a need for proppants improved to address both placement and crushability of the proppant still remains. Such improvements might be related to shape, density, material, and/or structure.

Although sand has played an important role in fracking and oil recovery, sand is not particularly strong and is often crushed in the smaller fractures of the well if it is even small enough to enter the smaller fractures or it is not flowable so it does not reach the smaller fractures and crushes. Brown sand (typically used) is not capable of withstanding high closure stresses above 6000 psi and white sand exhibits crush above 10,000 psi. Sand's weakness was the reason higher strength ceramic proppants were introduced. Alternatively, the sand may be too big to even reach the smaller fractures and then, of course, it is not effective relative to outflow.

To address the drawbacks of using sand, well-engineering science has developed proppants in a wide variety of strengths, sizes and make-up. Proppants may include higher strength ceramic proppants manufactured from sintered bauxite, kaolin, magnesium silicate, or blends and generally range between 8 and 140 mesh and may comprise nanoproppants, microproppants or, simply, proppants (mesh size is the number of openings across one linear inch of screen) (105 micrometers to 2.38 mm) depending upon customer specifications. Typically, larger particle sizes provide higher fracture conductivity. And, milling smaller particle sizes is expensive adding another reason to prefer larger particle sizes. But importantly, it has been determined that higher concentrations of smaller particles have a significant positive impact on propped fracture conductivity.

Microproppants are those particulates that are smaller than about 200 mesh on a D50 (D50 of 200 mesh is 100 microns, 100 mesh is 200 microns). The use of microproppants of adequate size and strength is likely to have a significant impact on oil production. Additional characteristics such as charge on the microproppants, surface texture and hardness, and internal lattice structure also contribute to their ability to be carried into the fractures further and to prop the fractures open. Because microproppants are smaller, they are better suspended in the fracking fluid, and therefore, obtain deeper penetration in the fracture and, at the same time, reduce the quantity of fluid necessary to complete the fracture.

Research shows that sand combined with certain other proppants, or blends of sizes of proppants may increase the well yield but that some of the oil reabsorbs and does not come in. The use of Microproppants could allow oil to flow to the main frac that would otherwise be reabsorbed onto the formation in the complex Frac region, thereby improving production by keeping smaller fractures open. Microproppants may also be employed in a blend of small and medium microparticles which may increase efficiency. Specifically, higher concentrations of more conductive proppants have a significant impact on propped fracture conductivity and, therefore, yield. Larger size LWC (lightweight ceramic) proppant mixed 40/70 with sand significantly improves the conductivity of the overall proppant pack, regardless of concentration. Low concentrations of 40/70 sand mixed with larger size LWC proppants have nearly the same conductivity as high concentrations of 40/80 LWC mixed with larger size LWC. Yet, despite the improved understanding and the variety of proppants available, the prior art problems remain.

Another property of proppants that is known to affect their performance comprises the proppant grain boundary character. Keep in mind that as liquids begin to solidify to a crystalline form, atoms start to gather (become packed). Spatially near atoms become arranged in a particular orientation and translate in a particular manner, forming a region called a grain. The area or boundary between one grain (comprising particles of a particular orientation) and another grain (comprising particles oriented differently) is called a grain boundary. The orientation of atoms in a grain is typically different than the orientation of atoms in a neighboring grain. When the misorientation is small, the grain boundary can be described as a dislocation (e.g., an edge dislocation wall) and is called a low-angle boundary. More pronounced misorientation is referred to as high-angle boundary.

A grain boundary can be described, then, as a disturbance or difference in orientation of the atomic packing. As may be expected, then, the grain boundary between two grains of a proppant effects character of the proppants and their performance and behavior relative to strength, deformability, porosity, flow back, and shard reduction. That behavior may be influenced by how and where the grain boundary forms and its properties.

Additionally, microproppants can comprise amorphous structures, short chain polymers. Some may exhibit charges that are positive or negative, or that are partially positive and partially negative at the same time. The charge on microproppants may be beneficial. If a neutral charge could be generated, it may act to assist the microproppants' placement. Further, at lower flow pressure the presence of a charge may have a higher impact on the amount of oil/gas that outflows. Specifically, as fluid reaches more remote locations in the fracture, the fluid will carry the microproppant. At low flow pressures, a neutral charge may positively affect yield; a uniform charge could be generated, and the charge could be adjusted as needed, the microproppants may create a barrier to reabsorption. Said another way, the charge carrying microproppant so delivered into the remote fracture area will impact the flow level for the oil and gas that flows out when pressures reverse.

A problem that arises with the use of proppants is their tendency to create or become shards. Shards are smaller pieces of a proppant, breaking off under pressure. Thereafter, these shards may move with the fluid and settle into crevices and fractures thereby reducing flow of oil and gas. Reduction of shard formation would be beneficial. There remains a need for additional crush-resistant, shard-resistant materials with appropriate grain boundary characteristics produced for use by the petroleum industry in the hydraulic fracturing process just described. These new materials could be employed for the purpose of producing petroleum fluids, such as oil, natural gas and natural gas liquids, from rock units that lack natural adequate pore space to allow these fluids to flow to a well.

In summary, there is a need for a process and product that enables proppants to be manufactured to be more crush resistant and deformable and to comprise grain boundaries that foster both more uniform size and shape of the crystalline structure, and good sphericity and roundness along with resistance to shard production. Proppants comprising these new characteristics could yield higher porosity and permeability of the proppant bed and would be expected to be used and applied in the same way as regular proppants. These new proppants would comprise grain boundaries that result in a degree of deformability of the proppant. This deformability would facilitate formation of a wafer-like substance made up, at least in part, of the novel proppant and resist shard formation. Preferably, use of such proppants would not require additional equipment or routines different than those used to apply regular proppants, but could result in higher yields.

Recently, attention has been paid to understanding how the gas and oil yield might be increased relative to these proppant characteristics including density, strength, and size. Specifically, if proppant density could be managed or tailored so that the proppant remains adequately suspended in the delivery fluid with a lower rate of settling out and, the proppant could be engineered to be strong enough to accomplish its purpose this improvement would be advantageous. To accomplish this goal, the interplay of proppant characteristics such as density, deformability, size, shape and crystalline structure and delivery fluid properties might be managed and used as a benefit to enable better and more targeted placement of the proppants. Such management could produce an increase in oil and gas production by holding open smaller fractures that are not now reached by the larger sized proppants, and also holding open more smaller, natural fractures thereby fostering fluid communication and connection between more fractures, allowing more opportunity for oil and gas to find their way out.

### BRIEF SUMMARY OF THE INVENTION

One possible solution to the problems previously presented is to employ microproppants particularly designed to address the problems in the prior art. Specifically, these designed microproppants are easily carried by the delivery fluid, with density and shape designed to foster fluid delivery but exhibiting crush strength (resistance) adequate to provide the desired strength to prop open complex fractures better and longer. Further, the designed proppants purposefully include molecular structure to control whether and how the proppant breaks under pressure. Additionally, the microproppant may actually comprise a microproppant composition and may be created using material that is neutral, exhibits a charge or, may be coated with a small particle oxide nanoparticle which may or may not provide a charge. The charge can be adjusted. Like-charged particles will repel and, therefore, managing the charge allows or facilitates flow and prevents reabsorption of microproppant onto the formation thereby fostering flow. Finally, some particles of the inventive microproppant may adhere or associate together providing an irregular shape which may lend additional advantages for propping open fractures. In summary, the present invention provides a microproppant and a composition specifically designed for the proppants' intended use. Its design addresses its volume, its crush strength, and its deformability among other characteristics.

Because the volume of the inventive microproppant is relatively high and its density is low compared to that required for conventional proppant, and the inventive proppant is deformable, employing strategies that place in the fractures a desired amount of proppant of the right size, shape, and durability (thereby holding or “propping” them open for an adequate time period) will become even more successful methods of increasing well yield. Further, the inventors determined that management and control of microproppant design relative to its composition will also foster control and predictability of shard production, i.e., design also affects the performance of the microproppant and its ability to maintain conductivity of the fracture.

The present invention provides new technology for fracking sand including a novel proppant. The novel proppant is crush resistant, and provides higher porosity and permeability to the proppant bed. It is also lighter. Therefore, the amount of friction reducers typically employed to carry proppants into a fracture may be reduced or eliminated altogether. Reducing the use of friction reducers not only reduces cost and increases process efficiency; it also reduces the problems friction reducers often cause such as plugging and reduction of flow. Further, microproppant loading can reduce the use of frac fluids and chemicals used in frac fluids which will, in turn, reduce damage to the formation, increase production, and reduce friction pressure at laminar flow regions. The inventive microproppants exhibit neutral or managed charge, comprise an appropriate level of deformability, and exhibit high levels of sphericity and roundness characteristics.

The novel proppant comprises an unusual surface having texture without the requirement of a coating to accomplish the texture. This deformable texture facilitates meshing together of proppant particles. It is theorized, that certain characteristics of the inventive wafer may facilitate; formation under pressure of a wafer or plug without employing surface chemistry and without a coating per se. This characteristic also reduces the problem of flow back.

The novel proppant maintains and fosters conductivity, even under high pressure. Further, it maintains permeability over longer time frames due, at least in part, to its crush resistance. The inventive proppant also resists or relatively reduces shard production while exhibiting said high crush resistance.

The present invention may be produced in a variety of particle sizes via precipitation effected by sulfates. Cure temperature is managed as means to tailor the particle relative to conductivity. This process, then, provides means to control production relative to particle size and conductivity.

Aluminum and zirconium chlorides are added alone or with any proppants including sand, silica or other compounds and/or mineral ores or minerals which provide the character of the new microproppant. The microproppant character and make up is controlled by the ratio of aluminum to zirconium or zirconium to aluminum and specific conditions which provide the character of the new microproppants. The new microproppant may be employed alone or with nano technology. The invention contemplates use of the new microproppant in a variety of methods. One exemplary method comprises employing nano particles 3-5 times larger than a water molecule which are injected first into the well and as the frac continues. Next, microproppants are added and, finally, frac sand. Proppants of varying sizes are needed to keep pathways of the natural complex fracture and far field areas open to allow flow of the gas and oil after the frac is complete. The novel microproppant includes hydrous metal oxides or hydrous metal pseudo-oxides or other materials, and reactive hydroxyl groups. These features facilitate creation of varied crystal lattice structures such as monoclinic and tetragonal, along with others. These lattice structures play an important role in the inventive proppants' functionality.

Monoclinic mixed with tetragonal lattice structures provide advantages relative to microproppant physical properties. Specifically, such mixed lattice structure provides resistance to cracking and formation of shards. In short, the mix provides a “stop” to crack formation that tetragonal lattice structures could foster; inclusion of monoclinic lattice structures with the tetragonal structures acts as a stop to cracking through the tetragonal lattice structures. Said another way, cracking through tetragonal structures stops when the crack encounters a monoclinic lattice or the tetragonal structure transforms to a monoclinic structure. But resistance to shard formation is only one feature of the inventive proppant.

Typically when microproppant is used, it can enter secondary fractures that are too narrow and restricted for conventional proppants, thereby providing fluid communication and paths through which the gas and oil may flow and be recovered. As the microproppants lodge in the secondary fractures, not only will these fractures be productive just after they are opened, but the inventive proppants also resist crushing, and flow back of the microproppant. Charge on the inventive proppant can also be tailored in order to encourage and facilitate flowback of oil and gas. Provided the microproppant is adequately placed, the inventive microproppant will keep the secondary fractures open, thereby providing time, space, and opportunity for gas and oil to outflow and be collected over a period much longer than the normal 90 day reduction curve observed when microproppants are not used. And also longer than the normal reduction curve when other microproppants are used.

The novel proppant of the present invention is crush resistant, provides higher porosity and permeability to the proppant bed than prior art proppants, (particularly in the complex or far field regions) and reduces damage to the carrier fluid relative to other proppants specifically comprising other metals. Using the novel proppant increases production, and reduces friction because the novel proppant does not settle out but remains suspended and reduces pressure in laminar flow regions. The novel proppant exhibits high levels of sphericity, and roundness characteristics. The subject proppant provides an improved resistance to plugging, and marked reduction in shards, while maintaining conductivity.

Finally, the present inventive proppant may be produced in a variety of particle sizes via precipitation effected by the type of sulfate employed. Cure temperature is managed as a means of controlling production. This process provides means to control production relative to particle size and future improved conductivity.

In short, the inventive proppant facilitates improved proppant placement in the complex natural fracture or far field area and exhibits improved proppant crush related characteristics.

### BRIEF DESCRIPTION OF THE DRAWINGS

FIG. 1 consists of Particle Size Distribution report 100 mesh Sand D5=67.8, D95=333, D50=182.5 mean size 14.01953 micrometers

FIG. 2 consists of Particle size distribution report 200 mesh, sand, D5=40.1, D95=199.6, D50-96.9

FIG. 3 consists of Particle size distribution report −100 mesh, microproppant, D5=0.31, D95=11.2, D50=6.1

FIG. 4 consists of Particle Size Distribution Report −325 mesh, microproppant D5=0.24 D95=10.94 D50=5.98

FIG. 5 consists of Particle Size Distribution Report −500 mesh, microproppant D5=0.26 D95=9.48 D50=5.08

FIG. 6 is a photograph microproppant magnification 800, before conductivity test

FIG. 7 is a photograph microproppant, magnification 800, after conductivity test

FIG. 8 is a photograph microproppant of FIG. 7 but magnification 3000 showing pores

### DETAILED DESCRIPTION AND BEST MODE OF IMPLEMENTATION

The present invention comprises a novel microproppant that exhibits improved performance under long-term fracture conductivity and permeability testing. The inventive microproppant may be tailored and may comprise a coating comprising sand with a small particle oxide. This microproppant oxide coating comprises an agglomerate of nanoparticles. Further, the microproppants of the present invention are less dense (e.g., 0.64 g/cm³) than conventional proppant sand (e.g., Carbo Naomite S Bulk Density about 1.31 g/cm³) and exhibit irregular shapes. Water's density is 1; the novel microproppant will, therefore, remain suspended more easily and are, therefore, easier to transport in the fluid and to place deeper in the fracture, improving propping ability. The inventive microproppants are stronger than many other microproppants and appropriate for deep well use. They exhibit neutral charge. Further, experiments show that the inventive microproppants exhibit longer particle suspension which could result in lower pumping pressure at laminar flow regions.

The size of the inventive microproppant (D5=0.3, D50=6.1, D95=11.2) is well below that of the conventional microproppants. Employing a deep understanding of the solution chemistry of the production process, the size of the microproppant can be purposefully varied as needed for the particular application. Conventional microproppant is 200 mesh (with a d50 of 100 microns). In contrast, the novel microproppant, as previously stated, can range, based on the d50, between 5 microns and 50 microns.

The novel microproppant can be employed as a stand-alone product to support the fracture or as a micro-particle-coating on conventional proppant sand to improve the conventional proppant transport and performance. These performance characteristics are attributed at least in part to the novel proppant's lower density than conventional proppant sand, and range between 20% and 120% the density of water.

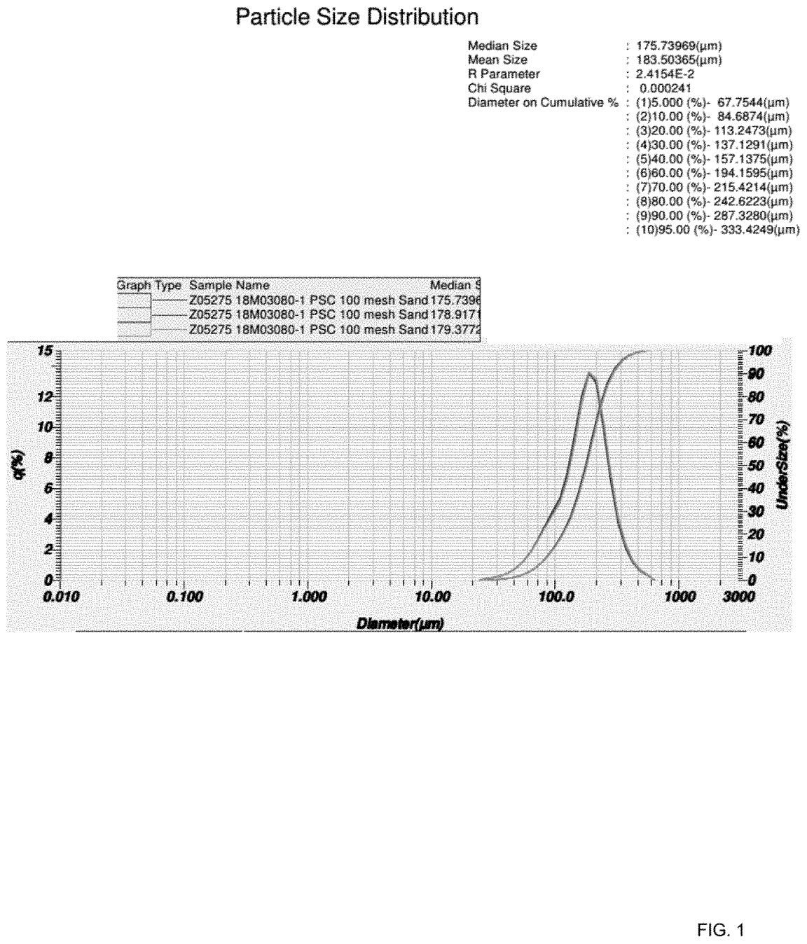

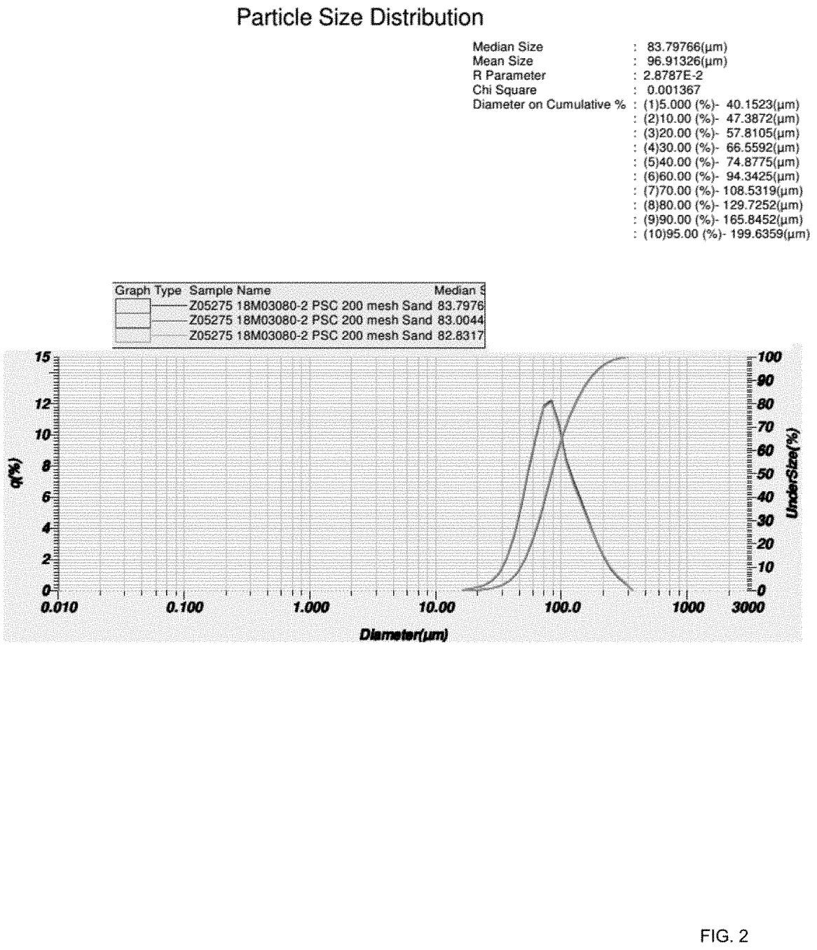

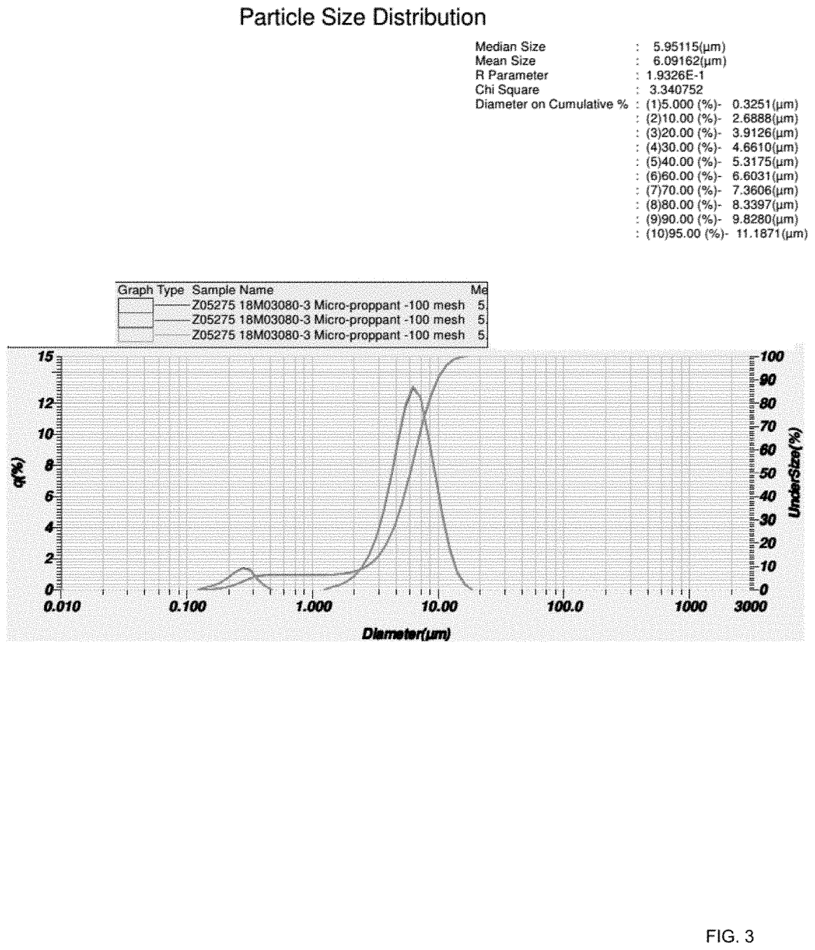

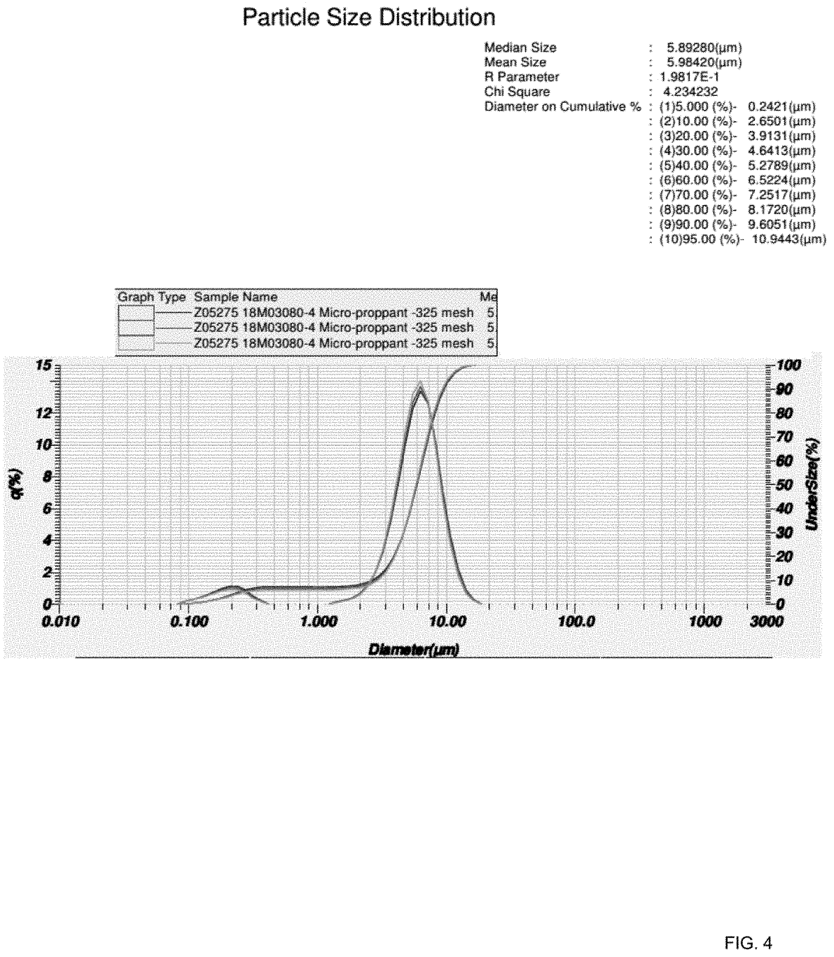

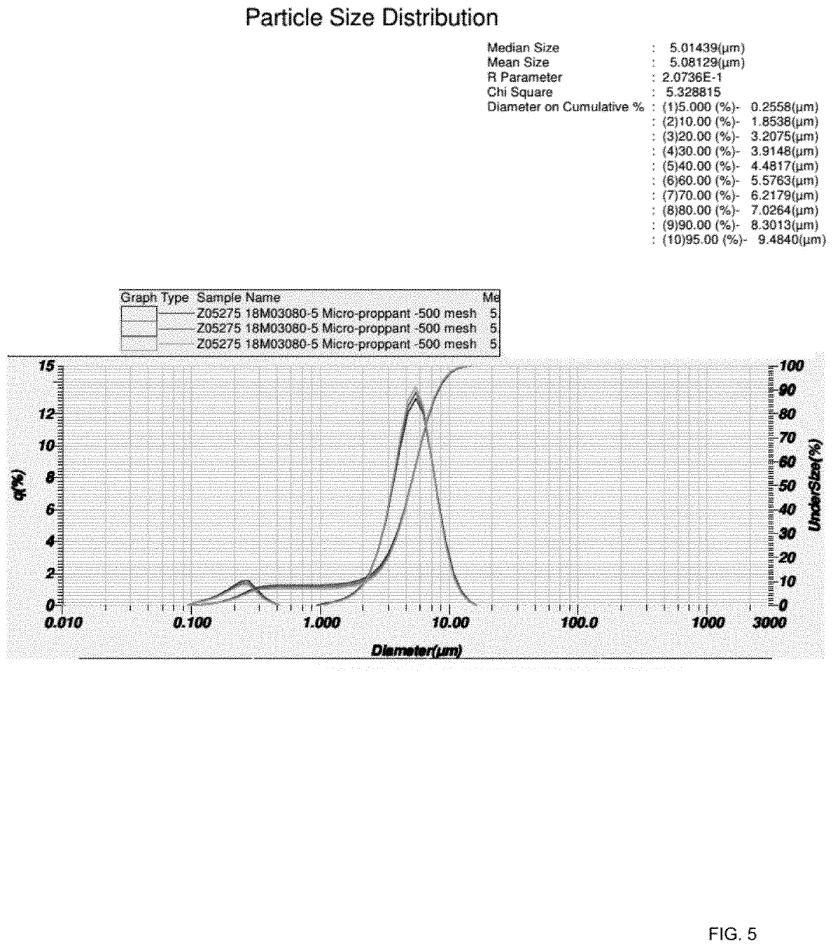

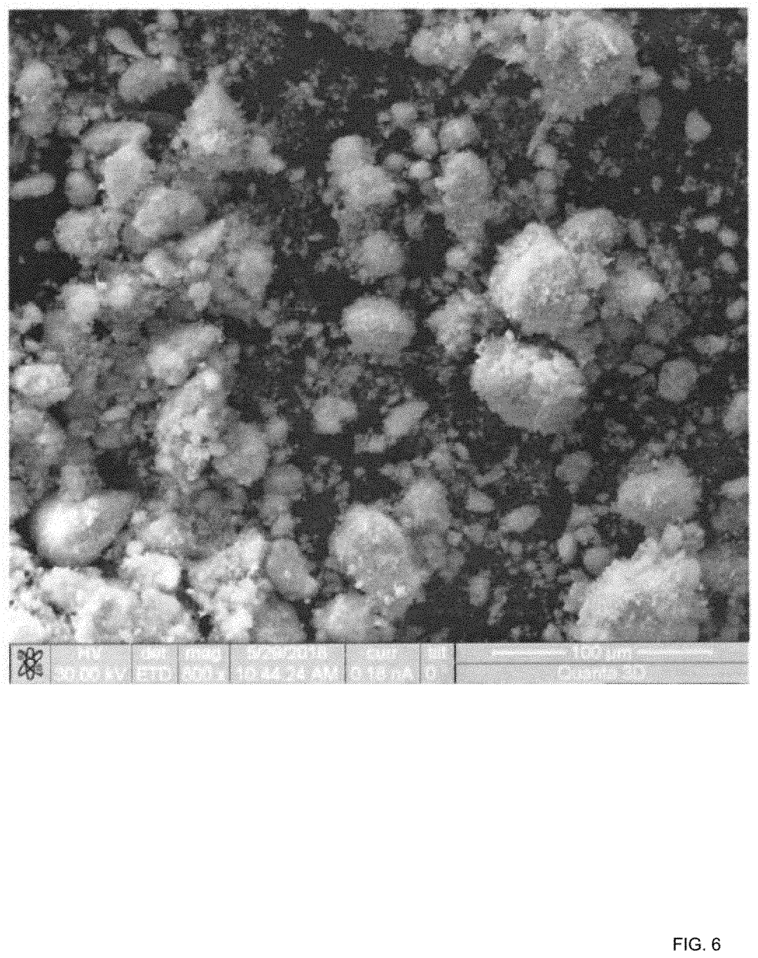

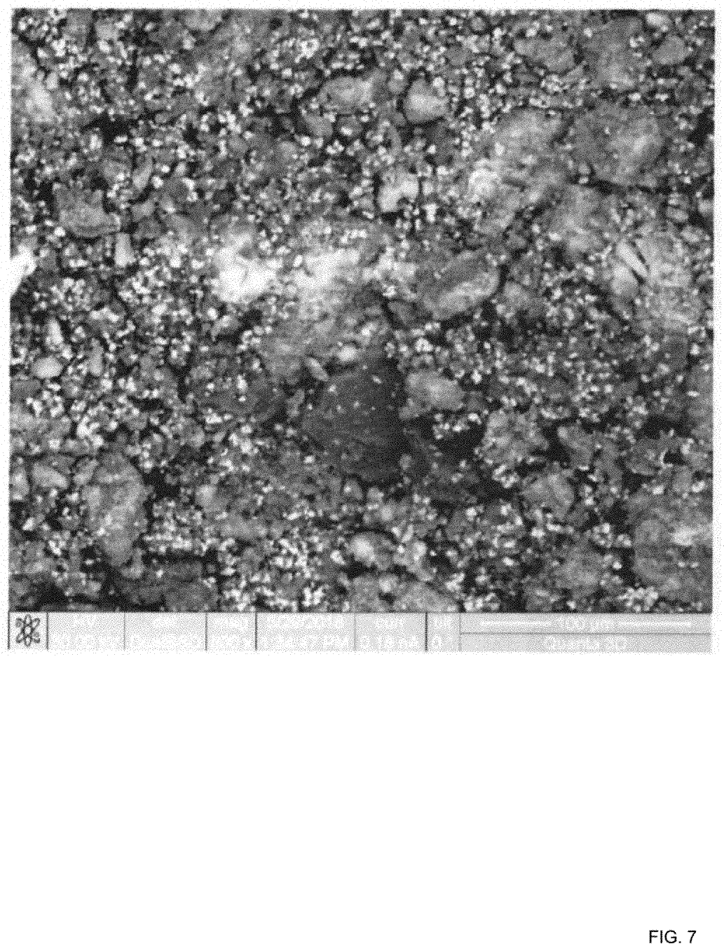

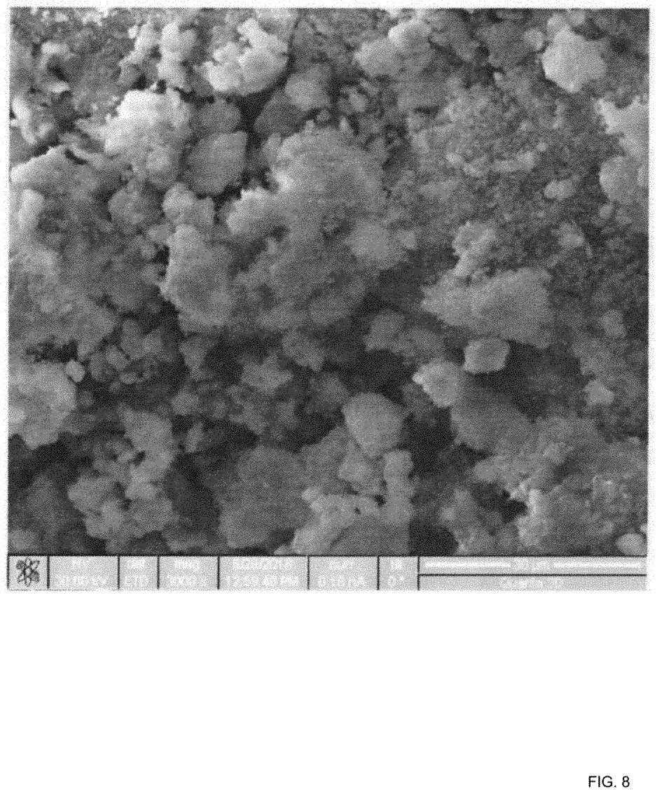

Varied lattice structure can relieve crush pressure, thereby reducing shard creation during production and use. Non-uniform lattice structure reduces the length of a plane along which a crystal could crack and become a shard. The novel proppants comprise varied lattice structure and do not crush per se although they are able to reduce their relative spacing as pressure increases. The subject microproppant is created with an appropriate particle size distribution (see FIGS. 1, 2 and 3). Referring to FIG. 3, the inventive microproppant −100 mesh exhibits D5=0.3 and D50=6.1, D95=11.2 compared with FIG. 1 of 100 mesh sand exhibiting D5=68, D50=183, D95=333 and FIG. 2 of 200 mesh sand exhibiting D5=40, D95=200 and D50=84. The larger particles of the inventive microproppant sit between and interspersed with the smaller ones, thereby preserving porosity even under pressure, while also reducing or avoiding shard creation and resultant plugging. The present invention's microproppants exhibit these characteristics, meet closure stress requirements, and resist diagenesis under downhole conditions which may include extreme temperatures, and extreme pressures. Analytical reports describing the article size distribution of the novel proppant are included as FIGS. 3-6; A study on Conductivity was also performed and these reports are included as Tables 1-3. Finally, enlarged photographs of the novel particles showing their irregular shape and size, are included in FIGS. 6-8. Permeability data pertaining to 30/50, 40/70, and the inventive material can be found in Tables 1-3 immediately below.

TABLE 1
30/50 sand

| | Time | Time | | Conductivity | Permeability | Width |
|---|---|---|---|---|---|---|
| Stress, psi | @ stress | (Total) | | (md-ft) | (Darcy) | (in) |
| 1,000 | 24 hrs | 24 | hrs | 2645 | 130 | 0.245 |
| 2,000 | 50 hrs | 74 | hrs | 2364 | 120 | 0.243 |
| 4,000 | 50 hrs | 124 | hrs | 1472 | 75 | 0.236 |
| 6,000 | 50 hrs | 174 | hrs | 798 | 43 | 0.225 |
| 8,000 | 50 hrs | 224 | hrs | 150 | 8 | 0.214 |
| 10,000 | 50 hrs | 274 | hrs | 30 | 2 | 0.207 |

2 lb/ft², 150° F., Ohio sandstone core wafers, 2% KCL substitute.

TABLE 2
40/70 sand

| | Time | Time | | Conductivity | Permeability | Width |
|---|---|---|---|---|---|---|
| Stress, psi | @ stress | (Total) | | (md-ft) | (Darcy) | (in) |
| 1,000 | 24 hrs | 24 | hrs | 1250 | 81 | 0.246 |
| 2,000 | 50 hrs | 74 | hrs | 1134 | 56 | 0.244 |
| 4,000 | 50 hrs | 124 | hrs | 868 | 44 | 0.239 |
| 6,000 | 50 hrs | 174 | hrs | 526 | 27 | 0.233 |
| 8,000 | 50 hrs | 224 | hrs | 200 | 11 | 0.223 |
| 10,000 | 50 hrs | 274 | hrs | 40 | 2 | 0.215 |

2 lb/ft², 150° F., Ohio sandstone core wafers, 2% KCL substitute.

TABLE 3
of sample 2

| | Time | Time | | Conductivity | Permeability | Width |
|---|---|---|---|---|---|---|
| Stress, psi | @ stress | (Total) | | (md-ft) | (Darcy) | (in) |
| 1,000 | 24 hrs | 24 | hrs | 5 | 0.3 | 0.226 |
| 2,000 | 50 hrs | 74 | hrs | 3 | 0.2 | 0.220 |
| 4,000 | 50 hrs | 124 | hrs | 1 | 0.1 | 0.208 |
| 6,000 | 50 hrs | 174 | hrs | 1 | 0.1 | 0.201 |
| 8,000 | 50 hrs | 224 | hrs | 1 | 0.0 | 0.195 |
| 10,000 | 50 hrs | 274 | hrs | 1 | 0.0 | 0.190 |

2lb/ft², 150° F., Ohio sandstone core wafers, 2% KCL substitute.

The present invention comprises the design of small particles of various zirconium compounds (e.g., oxides, hydroxides, and or pseudo-oxides/hydroxides) as a standalone proppant as well as mixed metal compounds mainly Zirconium and Aluminum. Other common metals can be considered, e.g., oxides, hydroxides, and or pseudo-oxides/hydroxides.

Specifically, small particles of the standalone zirconium compound or the mixed metal compounds can be enhanced with the addition of various diluents (i.e. quartz/sand; feldspar; and kyanite to name a few). The diluents can benefit, assist or “react” in several ways. One benefit is lowering the cost of the invented micro-proppant product. A second benefit is realized because the diluent can act as a transport assist “carrier” for the micro-proppant, such that the micro-proppant can be attached or blended into the diluent, thus allowing the micro-proppant to be dispersed more evenly throughout the fracture. As a third benefit, the diluent is transported farther because its combination with the micro-proppant reduces the density of the diluent. Fourth, the diluent can react, during a heating step, such that structural strength is improved for either the diluent or the micro-proppant. Fifth, the diluent can react with the micro-proppant such that the lattice structure of the final product contains varying levels of structurally stronger crystal lattices (i.e. monoclinic and tetragonal). The stronger lattices result because the diluents are reactive with mixed metal hydroxides or metal hydroxides thereby fostering the formation of the various lattice structures of the present invention.

In addition, the inventors have developed methods by which different charges on the novel proppant can be developed. In this way, the method can be used to tailor the proppant to selectively create lattice structure for crush strength and better conductivity based on the dominant production formation charge, while not creating excessive physical properties (i.e. crush, density, etc.) in the inventive proppant.

The present invention comprises mixed metal, amorphous metal, amorphous zirconium and aluminum chloride solutions reacted with a base. They exhibit adequate crush strength at well depths of 2,000 and up to about 15,000 feet. Specifically, sand or other diluents are added to small particles of zirconium or aluminum (typically in hydroxide form). The sand added may be, for example, 30-50 mesh, 40-70 mesh, 100 mesh, or 200 mesh and sizes therebetween, by way of example. Zirconium hydroxide will react with the aluminum hydroxide and upon filtering and washing the mixed metal hydroxides, they can be heated to form the aforementioned various crystal lattice structures which can be filtered and washed (if required) and heat treated, resulting in the desired properties.

The modification process can use diluents such as feldspar which, as suggested above, may change the lattice structure based on firing temperatures (e.g., zirconia may take any of three different lattice structures depending upon temperature, e.g., 900 C for mono, 900 C-1400 C for tetragonal and 1400 C and higher for cubic lattice structure). The diluents are reactive with mixed metal hydroxides or metal hydroxides thereby fostering the formation of the various lattice structures of the present invention.

One example process to produce a novel proppant of the present invention comprises the following: Make or otherwise obtain 0.5%-1.5% ZrO₂ in solution; add a sulfate group at 0.3-0.7% mole ratio to the solution of the zirconium compound, with high sheer and heat, to obtain an insoluble ZrSO₄ and wash off the sulfate by using a base to adjust the pH in a range from ˜3.5 to 10 thus replacing the SO4 group with the base ligand. The standalone invented product (i.e. zirconium oxide or zirconium hydroxide) can be produced by heating to various temperatures. Of course, to make the various mixed metal microproppants, before adjusting the pH higher (adding the base), a water soluble metal, (as an example, but not for limitation, aluminum chloride) can be added to the insoluble zirconium sulfate (ZrSO4) slurry. Again with good agitation, the pH can be adjusted with the type of bases mentioned above. Once sufficient base has been added to reach the pH ranges mentioned above, the mixed metal hydroxide can be filtered and then heated to produce a micro-proppant with the desired characteristics required for the end user or intended end use.

In general, then, to produce the inventive proppant, zirconium solutions (by themselves or mixed with aluminum solutions, typically in chloride form) are the starting material and diluents can be added to the starting materials as needed. Additionally, aluminum chloride (or other aluminum solutions) may be added with the zirconium sulfate or alone or with silica (i.e. quartz, other minerals or mineral ores) or other oxides to provide a new microproppant. The new microproppants may be employed either as a standalone proppant or as a component of a coating for a larger particle. The use of sulfate facilitates the creation of grain boundaries. The microproppant character and make up is controlled by the ratio of aluminum to zirconium, or zirconium to aluminum, as well as by heating or drying. Much more aluminum (it is a small atom, and is not a transition element) is added than zirconium (which always exhibits+4 ion in solution). But varying the zirconium ratio can be used to produce different microproppants and vice versa. Once the designer adjusts the ratio and heating criteria to gain the desired character of the product grains, then the grain product is ground, pounded, hammered or otherwise treated to result in the desired microproppant. During the grinding, pounding, and/or hammering the grain boundaries dictate how, when and where the grinding pressure will cause the inventive grains to separate (evident by the fact that fired (heated) proppants of the present invention are soft and easy to grind) and result in the desired microproppants.

What is claimed:

1. A microproppant composition for holding open a secondary fracture in a well comprising a plurality of small particles of one or more of zirconium, zirconium aluminum, and diluent added to a particle, said particle comprising size distribution comprising any one or more of D50 5 microns, 20 microns, and 50 microns.

2. The microproppant composition of claim 1, wherein at least a portion of said plurality of small particles comprises an agglomeration of small particle oxide nanoparticles.

3. The microproppant composition of claim 1 wherein at least some of the plurality of small particles comprise irregular shapes.

4. The microproppant composition of claim 2, wherein a portion of said plurality of small particles comprise a crush strength adequate for use at well depths between about 2,000 and about 15,000 feet.

5. A process for making a microproppant comprising sizing sand particles and at least partially coating a portion of said sand particles with a composition comprising a plurality of small particles of zirconium.

6. The microproppant composition of claim 1 wherein at least a portion of the microproppant comprises higher deformability than a remainder of the microproppant, thereby reducing sharding.

7. A microproppant for holding open secondary fractures in a well, said microproppant comprising varied lattice structures thereby withstanding higher crush pressure and reducing shard production as compared to microproppants of generally uniform lattice structure.

8. The composition of claim 1 wherein at least a portion of said zirconium, zirconium aluminum, and diluent is in the form of a small particle hydroxide comprising an agglomeration of nano particles.

9. The composition of claim 8 wherein the composition preserves porosity of the secondary fracture.

10. The composition of claim 9 further comprising larger particles, said preservation of porosity attributable at least in part to relative positioning of said larger particles and said small particles leaving space between said larger and small particles in the composition.

11. A novel microproppant for increasing oil and gas production, said microproppant comprising a plurality of larger particles interspersed with a plurality of smaller particles thereby preserving a higher level of porosity, said novel microproppant resulting from a process providing adjustable size and durability of said microproppant.

12. A microproppant composition comprising small particles of one or more of zirconium, zirconium/aluminum, aluminum/zirconium, and diluent with zirconium/aluminum, aluminum/zirconium added to sand said sand comprising particles of a size distribution of any of: 30-50 mesh, 40-70 mesh, 100 mesh, 200 mesh microproppant size range.

13. The microproppant composition of claim 2, further comprising sand, said sand comprising particles of a size distribution of any of: 30-50 mesh, 40-70 mesh, 100 mesh, 200 mesh, and aluminum.

14. The composition of claim 1 said zirconium in the form of a small particle oxide comprising one of: an agglomeration of nano particles or an association with sand.

15. The microproppant composition of claim 1 comprising microproppants of irregular shapes and nonuniform size thereby fostering transport of the microproppant with fluid.

16. The microproppant of claim 2 comprising an adjustable strength adequate for use at well depths ranging from about 2,000 to about 15,000 feet.

17. A process for making the microproppant composition of claim 1 comprising coating a plurality of sand particles with a small particle oxide of any one or more of zirconium and zirconium/aluminum and aluminum/zirconium.

18. A method for increasing the yield of a gas and oil well comprising using a fracking sand to fracture, said fracking sand comprising the microproppant composition of claim 1 and further comprising one or any combination of the following characteristics to increase yield, charge, deformability, size, strength, size distribution, and varied lattice structure.

19. The composition resulting from the process of claim 5 wherein most of the microproppants do not carry a charge.

20. The composition of claim 9 said composition comprising a level of deformability adequate to reduce sharding.

21. The microproppant of claim 7 wherein the secondary fractures are far field fractures said microproppant providing a coating on sand.

22. An oil and gas well comprising secondary fractures in far field into which a novel microproppant is pumped to increase oil and gas production from far field fractures, said microproppant comprising a plurality of larger particles between which a plurality of smaller particles become positioned, thereby fostering porosity, said novel proppant resulting from a process and comprising size and durability adjustable by said process relative to at least one characteristic of the well, and comprising grain boundaries tailored by said process to provide adequate crush strength, deformability, and resistance to shard formation.

23. The microproppant of claim 22 wherein the microproppant comprises non uniform size and irregular shape.

24. The microproppant of claim 23 said microproppant comprising zirconium and applied as a coating on sand.

25. A novel microproppant for propping open secondary fractures in a well, said novel proppant comprising adjustable size to accommodate its intended use and appropriate durability for its purpose, said microproppant comprising grain boundaries tailored to provide adequate crush strength and resistance to shard formation.

26. A novel proppant comprising increased crush resistance, a higher level of deformability, and hydrous metal and reactive hydroxy groups, said increased crush resistance provided by an improved grain boundary, said grain boundary resistant to cracking and formation of shards, said grain boundary comprising a mixture of a plurality of monoclinic lattice structure and tetragonal lattice structure.

27. The microproppant of claim 23 said microproppant comprising aluminum and applied as a coating on sand.
